(19) United States
(12) Patent Application Publication
(10) Pub. No.: US 2011/0119240 A1
(43) Pub. Date: May 19, 2011

(54) METHOD AND SYSTEM FOR GENERATING A BIDIRECTIONAL DELTA FILE

(76) Inventor: DANA SHAPIRA, Modiin (IL)

(21) Appl. No.: 12/947,561

(22) Filed: Nov. 16, 2010

Related U.S. Application Data
(60) Provisional application No. 61/262,204, filed on Nov. 18, 2009.

(51) Int. Cl. G06F 17/30

(52) U.S. Cl. 707/693; 707/822; 707/769; 707/E17.01; 707/E17.014

(57) ABSTRACT

The present invention relates to a system and method of generating an encoded bidirectional delta file to be used for reconstructing target and source files by decoding said bidirectional delta file, each of said target and source files comprising one or more substantially identical substrings, wherein each of said substrings is encoded within said bidirectional delta file by using a single pointer.

### CROSS-REFERENCE TO RELATED APPLICATIONS

This application claims priority benefit from U.S. Provisional Patent Application No. 61/262,204, filed Nov. 18, 2009, which is incorporated herein by reference in its entirety.

### FIELD OF THE INVENTION

The invention generally relates to the data compression field. More specifically, the present invention relates to a method and system for generating a single bi-directional delta file out of two given files.

### BACKGROUND OF THE INVENTION

According to the prior art, delta compression represents a target file T making use of a source file S. The general approach for differencing algorithms, which construct delta files, is to compress the target file T by determining common substrings between source file S and target file T, and then replacing these substrings by a copy reference. The way the representation of such copy items is implemented determines a minimum length of a copy item. The delta file is then encoded as a sequence of elements, which are either pointers to an occurrence of the same substring in source file S, or individual characters that are not part of any common substring. To improve compression performance, pointers to previously occurring substrings in target file T are also used. When the delta file is the sequence of differences between a given source file, which was chronologically generated prior to generation of the target file, it is called a forwards delta file. If the source file was generated after the generation of a target file, it is called a reverse delta file or a backwards delta file.

There are several prior art applications that benefit from the use of delta compression, since the new information that is received or generated is similar to the already presented information. Such applications include distribution of software revisions, incremental file system backups and archive systems, where using delta techniques is more efficient than using regular compression tools. For example, incremental backups cannot only avoid storing files that have not changed since the previous backup and save space by using a conventional file compression, but also can save space by differential compression of a file with respect to a similar (but not identical) version stored during the previous backup.

A bidirectional delta file provides concurrent storage and usage of forwards and backwards delta techniques in a single file. When it is desired to go back and forth between different file versions, bidirectional delta files are used, providing flexibility and processing time savings, thereby leading to the space storage efficiency and I/O (Input/Output) operation reduction. Therefore, instead of storing both source and target versions of a particular data file for future usage, a bidirectional file along with one of the versions of the data file can be used. For example, when a new revision is released to licensed users, the software distribution can be done by using bidirectional delta files. Once the target file is constructed by using a previous version of the target file, named a source file, and also by using a bidirectional delta file, the source file is no longer required and can be deleted, thus saving memory resources. Once the user is interested in obtaining a previous version of the target file, he can reconstruct the source file out from the target file by using the same bidirectional delta file.

According to the prior art, when software distribution is performed on a remote computer, providing forwards and backwards delta files, a user can transfer both these files and perform an upgrade on his personal computer, since memory resources are not always available on the distributor's computer. Therefore, there is a need in the art to reduce the number of transferred files and, in turn, reduce data traffic and reduce storage resources at both ends (also reducing I/O operations due to transferring a smaller number of bytes).

It should be noted that generating a delta file of two given files, such as source file S and target file T, can be conventionally done in two ways: by using LCS (Longest Common Substring) based algorithms (e.g., as presented by Heckel P. in the article titled “A technique for isolating differences between files”, CACM, volume 21(4), pages 264-268, 1978); and by using edit-distance based algorithms (e.g., as presented by Agarwal, R. C. et al., in the article titled “An approximation to the greedy algorithm for differential compression of very large files”, in Technical Report, IBM™ Alamaden Research Center, 2003, or as presented by W. F. Tichy, in the article titled “The string to string correction problem with block moves”, ACM Transactions on Computer Systems, volume 2(4), pages 309-321, 1984, pages 309-321; and others) to compute a delta file by using a reference file as part of the dictionary to enable further LZ (Lempel-Ziv) compression of the target file. According to the prior art, delta compression algorithms which are based on the LZ (Lempel-Ziv) compression technique significantly outperform the LCS based algorithms in terms of compression performance. Thus, Factor, M. et al. (in the article titled “Software compression in the client/server environment”, Proceedings of the Data Compression Conference, IEEE™ Computer Society Press, pp. 233-242, 2001) employs the LZ-based compression to compress source file S with respect to a collection of shared files that resemble said source file S; it should be noted that resemblance is indicated by files being of same type and/or produced by the same vendor, etc. Thus, better compression is achieved by reducing the set of all shared files to only relevant subset.

Burns R. C. et al. (in the article titled “In-place reconstruction of delta compressed files”, Proceedings of the ACM Conference on the Principles of Distributed Computing, ACM, 1998) achieve in-place reconstruction of standard delta files by eliminating write before read conflicts, where the encoder has specified a copy from a file region, where new file data has already been written. Shapira D. et al. (in the article titled “In place differential file compression”, The Computer Journal, pages 677-691, volume 48, 2005) also discloses in-place differential file compression, presenting a constant factor approximation algorithm based on a simple sliding window data compressor for the non in-place version of this problem, which is known as “NP-Hard” (it should be noted that NP-Hard is described, for example, by Garey M. R. et al., in the book titled “Computers and Intractability, a Guide to the Theory of NP-Completeness”, Bell Laboratories, Murry Hill, N.J., 1979). Motivated by the constant bound approximation factor, Shapira D. et al. modifies the algorithm so that it is suitable for in-place decoding, thereby presenting an In-Place Sliding Window Algorithm (IPSW). The advantage of the IPSW approach is its simplicity and speed, enabling performing the in-place decoding without consuming additional memory resources, and by using the compression that compares well with conventional methods (both in-place and not in-place).

Working on the compressed delta file without using a source file, is done, according to the prior art, in the framework of Compressed Delta Encoding, which generates the delta files of two given files S and T, while processing their compressed form. Klein, S. T. et al. (in the article titled “Modeling Delta Encoding of Compressed Files”, Proc. Prague Stringology Club, pages 162-170, PSC-2006, 2006, and in the article titled “Compressed Delta Encoding for LZSS Encoded Files”, Proc. Data Compression Conference, DCC-2007, pages 113-122, 2007) explore the compressed differencing problem on LZW (Lempel-Ziv-Welch) and LZSS compressed files, respectively, and present a model for constructing delta encodings on compressed files. Klein, S. T. et al. show that the constructed delta file is relatively much smaller than the corresponding input LZW and LZSS compressed files. In addition, Shapira, D. (in the article titled “Compressed Transitive Delta Encoding”, Proc. Data Compression Conference, DCC-2009, pages 203-212, 2009) introduces a problem of merging two delta files, also called the Compressed Transitive Delta Encoding (CTDE) problem. This problem relates to constructing a single delta file, which has the same effect (functionality) as the two given delta files, by working directly on the compressed files, without using a source file.

Also, Rochkind, M. J. (in the article titled “The Source Code Control System”, IEEE Transactions on Software Engineering, Volume 1(4), pages 364-370, 1975) introduces the Source Code Control System (SCCS), which is a model where each change made to the software module is stored as a discrete delta file. To produce the latest version of the source code module, SCCS follows the forward delta files from the beginning, applying them as it goes. Further, Revision Control System (RCS) described by Tichy W. F. (in the article titled “Design, Implementation, and Evaluation of a Revision Control System”, in Proceedings of the 6-th International Conference on Software Engineering, pages 58-67, 1982, and in the article titled “RCS a system for version control”, Software-Practice & Experience, volume 15(7), pages 637-654, 1985) was first to use reverse delta files. A reverse delta file describes how to go backwards in the developed history: it produces the desired revision if applied to the successor of that revision.

U.S. Pat. No. 6,349,311 discloses a method, in which a computer readable file of a first state is updated to a second state through the use of an incremental update, which provides the information necessary to construct the file of the second version from a file of the first version. In other words, U.S. Pat. No. 6,349,311 presents a method for generating a stored back-patch to undo the effect of forward patching. As a result, a back-update file (reverse delta file) is created, in order to allow future access to the previous version of a file, by providing the information necessary to construct the previous version out of the current version.

EP 1,259,883 presents a method and system for updating an archive of a computer file to reflect changes made to the file, and includes selecting one of a plurality of comparison methods as a preferred comparison method. The comparison methods include a first comparison method wherein the file is compared to an archive of the file and a second comparison method wherein a first set of tokens statistically representative of the file is computed and compared. When a file is being backed up, it is compared with its archived version, and both forward and backward delta files are generated and transmitted to the server for archiving. The server stores the file, as well as N backward delta files, that would enable it to reproduce a version of that file, which is up to N revisions old.

U.S. Pat. No. 6,542,906 discloses a method of and an apparatus for merging a sequence of delta files. The method comprises creating an initial merge structure from the base file and the first delta file in the sequence. A further merge structure is created from the initial merge structure and the next delta file in the sequence by comparing tokens in the initial merge structures and replacing reused tokens in the further merge structure with tokens in the initial merge structure.

Thus, there is a continuous need in the art to provide a method and system configured to construct a single bi-directional delta file out of two given files in an efficient way, thereby relatively significantly improving delta file compression, and in turn, relatively significantly saving storage resources.

### SUMMARY OF THE INVENTION

The present invention relates to a method and system for generating a single bi-directional delta file out of two given files.

According to an embodiment of the present invention, a method is presented for generating an encoded bidirectional delta file to be used for reconstructing target and source files by decoding said bidirectional delta file, and of said target or source files comprising one or more substantially identical substrings, wherein each of said substrings is encoded within said bidirectional delta file by using a single pointer.

According to another embodiment of the present invention, the target file is reconstructed by using the source file and the bidirectional file.

According to another embodiment of the present invention, the source file is reconstructed by using the target file and the bidirectional file.

According to still another embodiment of the present invention, the method further comprises determining the substantially identical substring within each one of the target and source files by searching said target and source files.

According to still another embodiment of the present invention, the substantially identical substring is the substring having a predefined length, said substring determined when starting searching the target and source files from a corresponding location within said target and/or source files.

According to still another embodiment of the present invention, the method further comprises continuously updating the corresponding location within the target and source files.

According to a further embodiment of the present invention, the method further comprises adding at least one flag bit to each of the substantially identical substrings.

According to still a further embodiment of the present invention, the substantially identical substring is an aligned substring.

According to still a further embodiment of the present invention, the substantially identical substring is a non-aligned substring.

According to still a further embodiment of the present invention, the substantially identical substring is a self-pointer.

According to still a further embodiment of the present invention, the method further comprises compressing the bidirectional delta file by using at least one compression method.

According to an embodiment of the present invention, a system is configured to generate an encoded bidirectional delta file to be used for reconstructing target and source files by decoding said bidirectional delta file, each of said target or source files comprising one or more substantially identical substrings, wherein each of said substrings is encoded within said bidirectional delta file by using a single pointer.

According to an embodiment of the present invention, is provided a program storage device readable by machine, tangibly embodying a program of instructions executable by the machine to perform a method of generating an encoded bidirectional delta file to be used for reconstructing target and source files by decoding said bidirectional delta file, each of said target or source files comprising one or more substantially identical substrings, wherein each of said substrings is encoded within said bidirectional delta file by using a single pointer.

### DEFINITIONS, ACRONYMS AND ABBREVIATIONS

Throughout this specification, the following definitions are employed:

Delta File—a delta file represents a target file T with respect to a source file S. Usually, a delta file is encoded as a sequence of three types of elements, which are either pointers to an occurrence of the same substring in source file S, or pointers to previously occurring substrings in target file T itself, or individual characters that are not part of any common substring. Hereinafter, the delta file of target file T with respect to source file S is denoted by Δ(S,T).

Forwards Delta File—is a delta file, in which a source file S was chronologically generated prior to generating a target file T.

Backwards Delta File—is a delta file, in which a source file S was chronologically generated after the generating of a target file T.

Bidirectional Delta File—is a two-way file, which represents a combination of both forwards and backwards delta files in a single file. The fundamental approach of storage savings in the bi-directional delta file represents a common substring of source file S and target file T using a single copy reference, unlike two independent copies in the forwards and backwards delta files. Hereinafter, the bidirectional file of two given files S and T is denoted by BDΔ(S,T).

LZSS Encoding/LZSS Compression—represents a compression scheme designed by Lempel-Ziv-Storer and Syzmanski (as presented, for example, in the article of Storer J. A. et al., titled “Data Compression via Textual Substitution”, JACM, volume 29(4), pages 928-951, 1982) for compressing a single file using a sliding window. In LZSS, a text is encoded as a sequence of elements which are either single characters, or pointers to previously occurring strings, encoded as ordered pairs of numbers, denoted as (off, len), where “off” is the number of characters from the current location to the previous occurrence of a substring, matching the one that starts at the current location, and “len” is the length of the matching string. For example, if T=acdeabceabcdeaeab, then LZSS(T)=acdeabc(4,4)(9,3)(7,3).

Self-Pointer—is a pointer used to copy a substring from the already scanned portion of the file to the position that corresponds to the pointer in the decompressed file.

### BRIEF DESCRIPTION OF THE DRAWINGS

In order to understand the invention and to see how it may be carried out in practice, various embodiments will now be described, by way of non-limiting examples only, with reference to the accompanying drawings, in which:

FIG. 1A is a schematic block-diagram of using forwards and backwards delta files, according to the prior art;

FIG. 1B is a schematic block-diagram of a conventional delta file structure, according to the prior art;

FIG. 2A is a schematic block-diagram of generating a bidirectional delta file, according to an embodiment of the present invention;

FIG. 2B is a schematic block-diagram of a bidirectional delta file structure, according to an embodiment of the present invention;

FIG. 3 is a schematic flow-chart of solving a maximum alignment sequence problem, according to an embodiment of the present invention;

FIG. 4 is a schematic illustration, which visually represents the problem of the method presented in FIG. 3.

FIG. 5A and FIG. 5B is a schematic flow-chart of solving a maximum alignment sequence problem using a minimum number of blocks, according to an embodiment of the present invention;

FIG. 6 is a schematic flow-chart of constructing a bidirectional delta file for given source file S and target file T, according to an embodiment of the present invention;

FIG. 7 is a schematic flow-chart of constructing a bidirectional delta file for given source file S and target file T, according to another embodiment of the present invention;

FIGS. 8A and 8B are schematic illustrations, which visually represent differences between BASIC_BIDIRECTIONAL_DELTA and NON_ALIGNED_BD methods, presented in FIGS. 6 and 7, respectively, according to an embodiment of the present invention; and

FIG. 8C is a schematic illustration of a case, which may be desired to be avoided when using the BASIC_BIDIRECTIONAL_DELTA and NON_ALIGNED_BD methods, presented in FIGS. 6 and 7, respectively, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Unless specifically stated otherwise, as apparent from the following discussions, it is appreciated that throughout the specification discussions utilizing terms such as “processing”, “computing”, “calculating”, “determining”, or the like, refer to the action and/or processes of a computer that manipulate and/or transform data into other data, said data represented as physical, e.g. such as electronic, quantities. The term “computer” should be expansively construed to cover any kind of electronic device with data processing capabilities, including, by way of non-limiting example, personal computers, servers, computing systems, communication devices, processors (e.g. digital signal processor (DSP), microcontrollers, field programmable gate array (FPGA), application specific integrated circuit (ASIC), etc.) and other electronic computing devices. Also, operations in accordance with the teachings herein may be performed by a computer specially constructed for the desired purposes or by a general purpose computer specially configured for the desired purpose by a computer program stored in a computer readable storage (memory) medium (device/system).

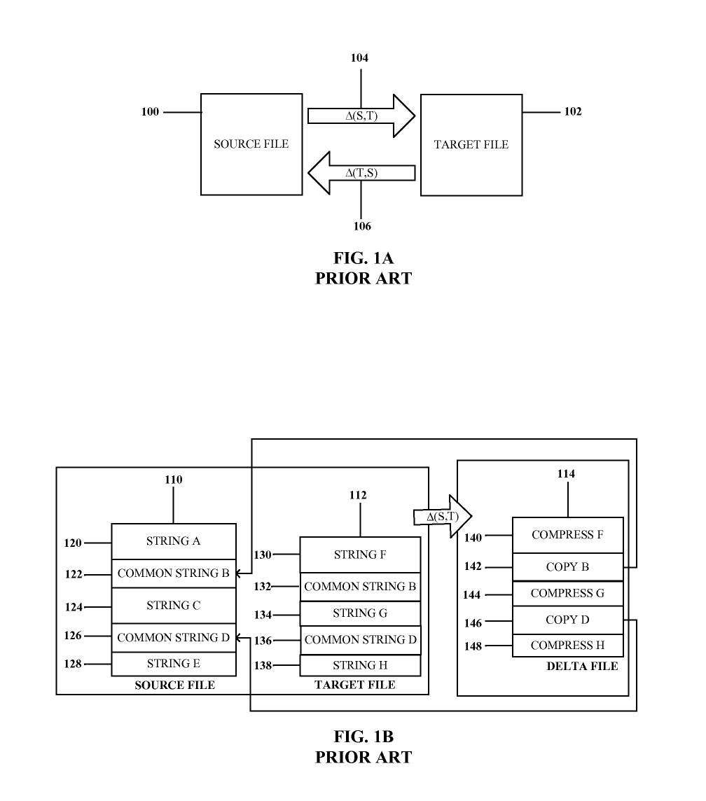

FIG. 1A is a schematic block-diagram of using forwards and backwards delta files, according to the prior art. Given a source file S, denoted as 100, and a target file T, denoted as 102, it is supposed that Δ(S,T) denotes the forwards or backwards delta file of target file T with respect to source file S, depending whether source file S was chronologically generated (created) before or after the generation of target file T. A forwards delta encoding 104 represents the target file T with respect to S. By applying the delta file Δ(S,T), denoted as 104, on source file 100, a target file 102 can be generated. Symmetrically, a backward delta encoding 106 represents the source file S with respect to T. By applying the delta file Δ(S,T) 106 on target file 102, a source file 100 can be generated. Both forwards and backwards delta files are composed of copies to common substrings and the encoding of the remaining characters. For example, it is supposed that source file S is the string of “xxxabcdefxablmn”, and target file T is the string of “abcdxyzlmnxxx”. Common substrings of S and T are substrings that occur in both, e.g. “abcd”, “lmn” and “xxx”. In Δ(S,T) the common substrings are copied from S instead of writing them explicitly, while in Δ(T,S), the common substrings are copied from T. The remaining characters which are not part of the common substrings are encoded in a separate way, e.g. as the encoding of explicit individual characters or compressed against the already scanned portion of the target file.

FIG. 1B is a schematic block-diagram of a conventional delta file structure, according to the prior art. The source file 110 and the target file 112 share common substring 122, 126, 132 and 136. In the delta file 114, that represents target file 112 with respect to source file 110, the common substrings are replaced by pointers, 142 and 146, to the source file. String F 130, String G 134 and String H 138 of target file (T) 112 are the remaining strings, which in the delta file are replaced by their compressed form 140, 144 and 148, respectively, e.g., by using a conventional LZSS algorithm. It should be noted that the non-common portions of the source file, referring to String A 120, String C 124 and String E 128, are generally not relevant to the delta file, since it represents only the target file. Usually, the delta files (forwards and backwards) can be generated by using a format of individual characters and copy items, where copies refer either to source file S or to target file T itself. The copies are initially described in the form of ordered pairs, (pos, len) and (off, len) for pointers to source file S and target file T, respectively. The second component, “len”, in both types of pointers describe the length of the reoccurring substring, which is the number of its characters. The position component, “pos”, of a pointer to the source file S refers to a copy of a substring starting at position “pos” in said source file S. The “off” component of a pointer to the already scanned portion of the target file T is the number of characters from the current location to the previous occurrence of a substring matching the one that starts at the current location.

The conventional delta files, therefore, usually use three types of items: pointers into the source file, self-pointers and raw characters such as the ASCII characters. To distinguish between the three, it is supposed that a flag bit of a copy from the base file is denoted by “BP” (Base Pointer flag bit), and a copy from the target file itself is denoted by “OP” (Offset Pointer flag bit). Thus, Base Pointers of Δ(S,T) are pointers from target file T to source file S, and Offset Pointers of Δ(S,T) are self-pointers in target file T. For example, it is supposed that source file S is the string of “abcdxxxdyyz”, and target file T is the string of “yyzzzabcdyyzzz”, both starting at index “0”. The delta file representing T with respect to S is Δ(S,T)=(BP,8,3)zz(BP,0,4)(OP,9,5). The triplet (BP,8,3) refers to a pointer into the Base file, S, in this case, (indicated by the flag bit “BP”) and refers to the string “yyz” that starts at position “8” of S, and has 3 characters. The characters are then encoded individually as raw characters zz. The triplet (BP,0,4) refers to the string “abcd” that starts at position “0” of S, and has 4 characters, and the triplet (OP,9,5) refers to the string “yyzzz” that can be copied from 9 positions before the current location in T.

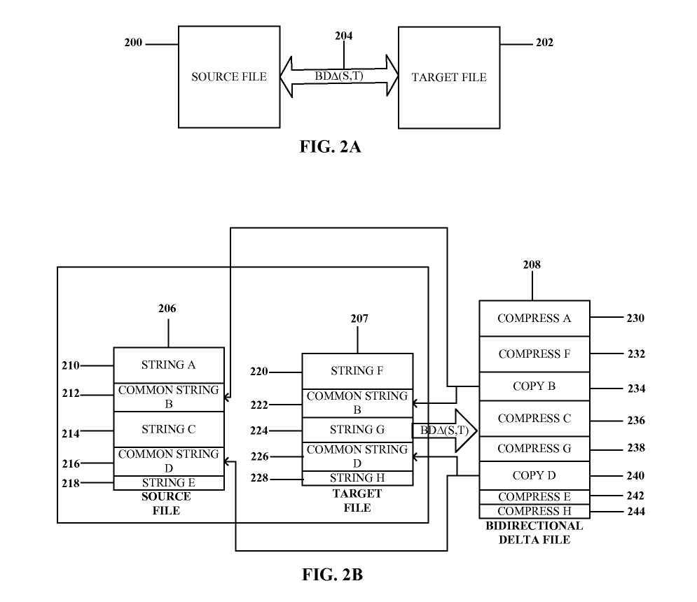

FIG. 2A is a schematic block-diagram for generating a bidirectional delta file, according to an embodiment of the present invention, thereby enabling reconstructing both source and target files. A bidirectional delta file is denoted by BDΔ(S,T), which is a two-way differencing file, enabling in an efficient way to combine the forward and backward delta files (deltas) into a single file. Given a source file S, denoted as 200, and a target file T, denoted as 202, it is illustrated what happens when generating a bidirectional delta file 204. The same single bidirectional delta file 204 can be decompressed by using source file 200 (in order to generate target file 202), and can be further decompressed using target file 202 (in order to regenerate source file 200). According to an embodiment of the present invention, the approach of storage savings in the bidirectional delta file relates to the encoding (referencing) of a common (substantially identical) substring (of source file S and target file T) within said bidirectional delta file by using a single copy reference (pointer), compared to obtaining two independent copies in the forwards and backwards delta files.

FIG. 2B is a schematic block-diagram of a bidirectional delta file structure, according to an embodiment of the present invention, thereby enabling reconstructing both source and target files. Source file (S) 206 and target file (T) 207 share common (substantially identical) substrings 212, 216, 222 and 226. In bidirectional delta file 208, which is used to represent T 207 with respect to S 206 and vice-versa, the common substrings are replaced by dual pointers 234 and 240 that point both to source file S and target file T. When decompressing the bidirectional delta file BDΔ(S,T) 208, the pointer into source file S is referred when target file T is constructed, and the pointer into T is referred when source file S is constructed. String A 210, String C 214, and String E 218 of source file S, String F 220, String G 224 and String H 228 of target file T are the remaining strings of the source and target files, which in the bidirectional delta file are replaced by their compressed form 230, 236, 242 and 232, 238, and 244, respectively, by using for example a conventional LZSS algorithm. It should be noted that the compressed form of the non-common portions of the source and target file, i.e., portions 230, 236, 242, 232, 238 and 244 in bidirectional delta file 208, are ordered so that the source file items are placed prior to the target file items. According to another embodiment of the present invention, a flag bit can be used to indicate whether the item is related to source file S or to source file T. Alternatively, the items can be intermixed (reordered).

It should be noted that, generally, a first attempt for solving the problem of choosing the “best” set of common substrings of two given files is by looking at the corresponding delta files. Selecting the same common substrings chosen by the differencing algorithm, such as a greedy delta encoder (that scans the target file from left to right choosing the longest (or any other predefined length) common substring from each position and continuing the process right after that substring) may raise difficulties, which stem from the fact that the corresponding delta files are usually not symmetric. Not only do the forwards and backwards delta files choose different substrings for pointer references, but even if the same substring is represented by a reference, it does not necessarily use an identical pointer to represent such a copy. Using the previous example, it is supposed that source file S is the string of “abcdxxxdyyz”, and target file T is the string of “yyzzzabcdyyzzz”, both starting at index “0”. As before, the delta file used to construct T with respect to S is Δ(S,T)=(BP,8,3)zz(BP,0,4)(OP,9,5). The triplet (BP,8,3) refers to a pointer into the Base file, S, in this case, indicated by the flag bit “BP”, refers to the string “yyz” that starts at position “8” of S, and has 3 characters. The characters are then encoded individually as raw characters zz. The triplet (BP,0,4) refers to the string “abcd” that starts at position “0” of S, and has 4 characters. The triplet (OP,9,5) refers to an Offset Pointer into the Target file itself, T, in this case, (indicated by the flag bit “OP”) and refers to the string “yyzzz” that can be copied from 9 characters before the current position, meaning that the reoccurring substring “yyzzz” occurs at positions “0” and “9” in T, and the difference between these positions is 9. This reoccurring substring has 5 characters. The reverse delta file representing S with respect to T is Δ(S,T)=(BP,5,4)xxx(BP,8,4). The triplet (BP,5,4) refers to a pointer into the Base file, T, in this case, (indicated by the flag bit “BP”) and refers to the string “abcd” that starts at position “5” of T, and has 4 characters. The characters are then encoded individually as raw characters xxx, and the triplet (BP,8,4) refers to the string “dyyz” that starts at position “8” of T, and has again 4 characters. Although the substring “abcd” is represented by pointer references in the both deltas (within delta file 114), the corresponding triplets are different ((BP,0,4) corresponds to “abcd” in Δ(S,T) and (BP,5,4) corresponds to “abcd” in Δ(S,T)). Moreover, the common substring “dyyz” is represented by (BP,8,4) in Δ(S,T). By decoding (BP,0,4)(OP,9,5) in Δ(S,T), the substring “abcdyyzzz” of T is obtained, said substring containing the substring “dyyz” (the substring “dyyz” overlaps the decoding of two triplets (BP,0,4) and (OP,9,5) in Δ(S,T)). This shows that common substrings are not necessarily copied from the alternative file, since in T, “yyzzz” is copied from its previous occurrence in T and not from S. It should be noted that the prefix “d” of “dyyz” string is copied from source file S using the triplet (BP,0,4), but this triplet refers to the occurrence of “d” at the third position of S and not the one which occurs at position “7” of S and refers to the common substring “dyyz”. This example illustrates that choosing a set of common substrings based on an independent (left to right) parsing of S and T files may result in a small number of short reoccurring substrings. Further, it can be required to determine regions of the two files that are substantially identical by performing a parallel scan of the files.

According to an embodiment of the present invention, an alignment of given strings in files S and T is a parsing of both of them according to their common substrings so that the common substrings occur in the same relative order. In other words, a set of substrings is aligned if by writing T below S and drawing straight lines between corresponding matches, no lines cross each another. The common substrings (contiguous matching characters) of an alignment are called blocks.

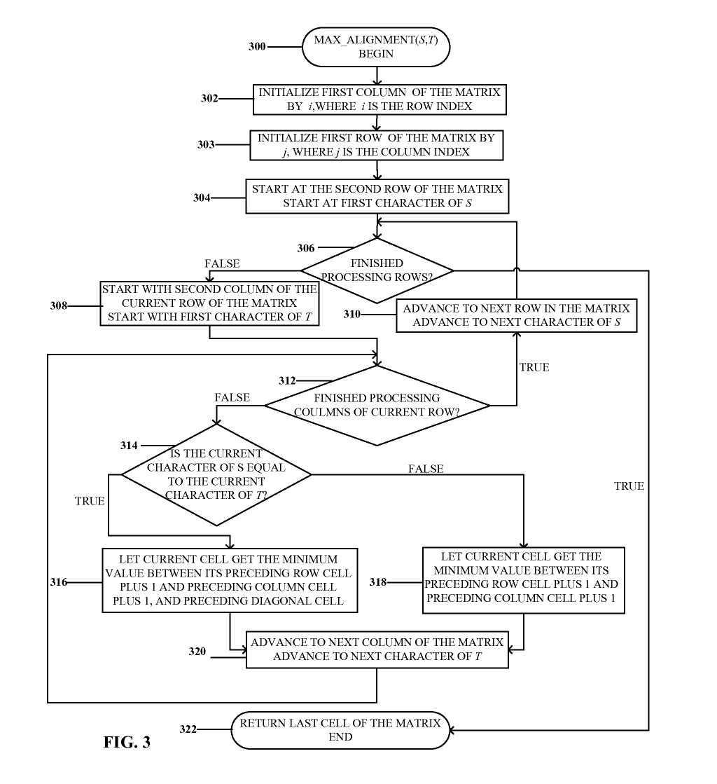

FIG. 3 is a schematic flow-chart of solving a maximum alignment sequence problem, according to an embodiment of the present invention. Given two strings within files S and T, respectively, the (global) sequence alignment problem can be defined as a problem in determining a maximal length alignment, according to an embodiment of the present invention. Generally, an alignment with k ordered blocks β₁, β₂, . . . , βₖ, where a block is a common substring of S and T, is supposed to be of maximal length if

$${\sum }_{i = 1}^{k} \vert {β}_{i} \vert$$

has the maximum value of all alignments of S and T, where |βᵢ| denotes the length of block βᵢ. It should be noted that not all alignments of S and T necessarily have the same number of blocks. Instead of referring to the aligned blocks, βᵢ (1≦i≦k), the contiguous characters of S or T between the blocks can be referred to as gaps, according to an embodiment of the present invention. Thus, according to another embodiment of the present invention, the alignment problem can be defined as a problem of minimizing the accumulated lengths of the gaps.

The edit distance problem is another way to measure similarity between two given strings. The original problem was defined as finding the minimum number of insertions, deletions and substitutions in order to transform one string to another. Here, only character insertions and character deletions are considered, and the focus is on uniform costs of the operations involved. Otherwise, the costs are specified in a given scoring matrix. An optimal alignment is an alignment that yields the best edit distance. A gap is the result of the deletion of one or more consecutive characters in one of the strings.

The similarity of two strings of sizes n and m, respectively, and the associated optimal alignment, can be computed using dynamic programming in O(n·m) time and space by means of conventional techniques, such as presented by Gusfield D., in the book titled “Algorithms on Strings, Trees and Sequences”, Computer Science and Computational Biology, Cambridge University Press, Cambridge, 1997. If there is no need to reconstruct the alignment, O(n+m) space suffices.

Given S=s₁•s₂ • • • sₙ, and T=t₁•t₂ • • • tₘ, a matrix A of size (n+1)×(m+1), which suits the lengths of source file S and target file T, is used. First column cells of the matrix are initialized, at step 302, by i, where i stands for their row index, to indicate i character deletions for converting S to T. First row cells are initialized, at step 303, by j, where j refers to their column index, to indicate j character insertions for converting S to T. This is done by using the following formulations, for example: ∀0≦i≦n A[i,0]←i; ∀0≦j≦m A[0,j]←j, where i goes over all rows of the matrix and j goes over all columns of the matrix. A[i,0] refers to cells in the matrix corresponding to column “0” (the first column), and A[0,j] refers to row “0” of the matrix (i.e., the first row). After the matrix is initialized, the computation proceeds by moving through all rows of the matrix, at steps 304, 306 and 310, and progressing through all columns at the current row, at steps 308, 312 and 320, in parallel to scanning the source string within the file S and the target string within the target file T. Each row corresponds to a different character of the source string (at steps 304 and 310), and each column of the matrix corresponds to a character of the target string (at steps 308 and 320). At steps 316 and 318, each cell A[i,j], in the matrix A is assigned the value of the minimum of:
The value in the diagonal cell A[i−1,j−1] in case of a match between sᵢ and tⱼ, where sᵢ is the i^{th} character of S, and tⱼ is the j^{th} character of T; (at step 316)
an horizontal gap, by referring to “1” plus the value in the preceding row cell A[i−1,j] (character deletion); (at steps 316 and 318)
a vertical gap, by referring to “1” plus the value in the preceding column cell A[i,j−1] (character insertions); (at steps 316 and 318)

At step 316, which is performed if there is a match between the current character sᵢ of the source string and the current character tⱼ of the target string (the match that is prior determined at step 314), the following formula is used: A[i,j]←min(A[i−1,j]+1, A[i,j−1]+1, A[i−1][j−1]) which relates to the minimum value between “1” plus the value in the preceding row cell (A[i−1,j]+1), “1” plus the value in the preceding column cell (A[i,j−1]+1), and the preceding diagonal cell (A[i−1][j−1]). It should be noted that step 318 is performed if there isn't a match between the current character sᵢ of source string and the current character tⱼ of the target string (the match that is prior determined at step 314), and the formula used is A[i,j]←min(A[i−1,j]+1, A[i,j−1]+1), which relates to the minimum value between “1” plus the value in the preceding row cell (A[i−1,j]+1) and “1” plus the value in the preceding column cell (A[i,j−1]+1). At step 322, the minimum number of operations required in order to transform S into T is attained in the last cell of the matrix, A[n,m] (where n and m suit the lengths of source file S and target file T, respectively).

The maximum value of all alignments that result from this minimum score is the number of characters of the blocks of the alignment. In order to construct the actual blocks of the alignment that have this maximum value, or possible multiple maximal alignments that have the same maximum value, traversing this matrix from its last cell backwards to its first cell is needed such as presented by Gusfield D., in the book titled “Algorithms on Strings, Trees and Sequences”, Computer Science and Computational Biology, Cambridge University Press, Cambridge, 1997.

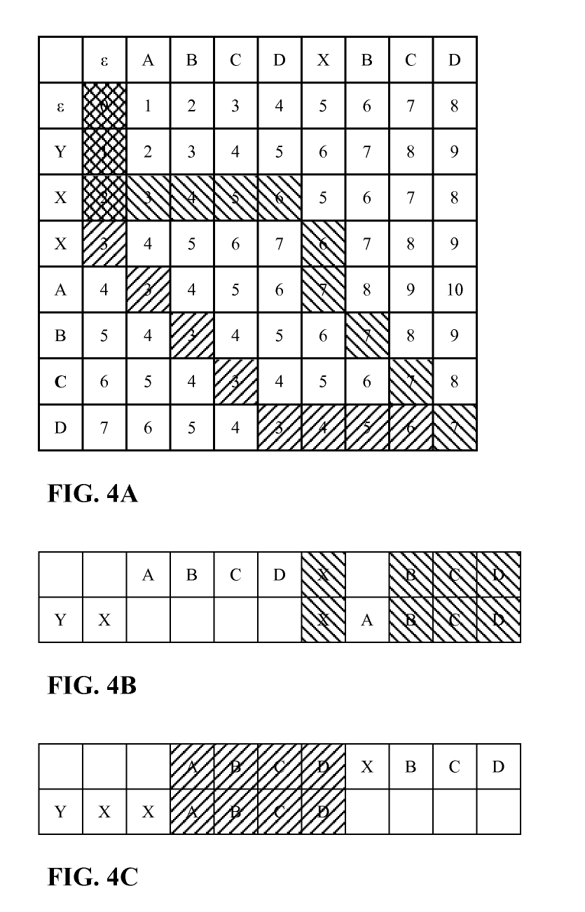

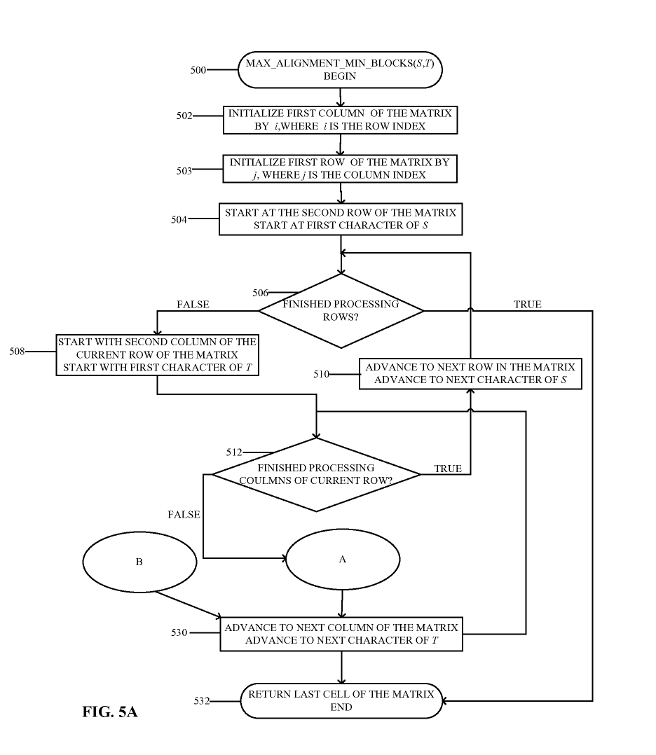

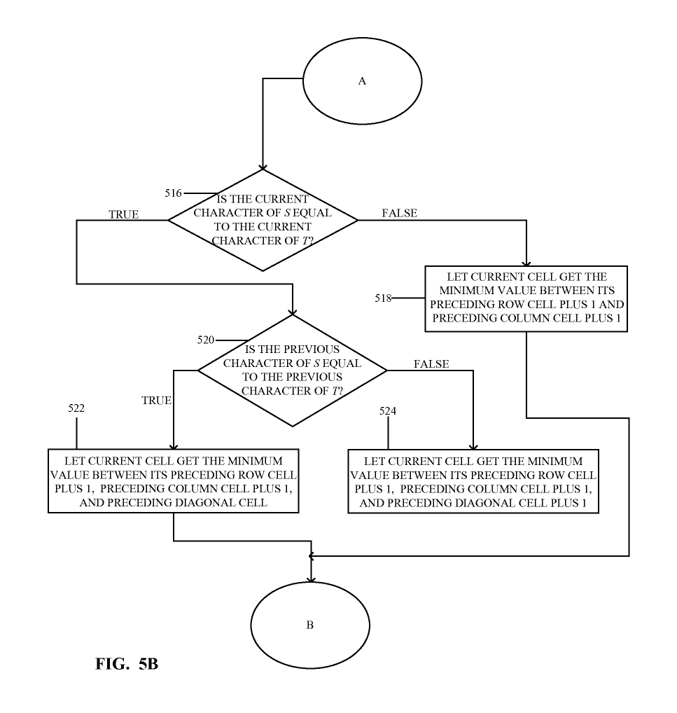

The algorithm presented in FIG. 3 is a first attempt for building a bidirectional delta file using dynamic programming for computing the maximum alignment of the two input files. However, the traditional Max Alignment Algorithm is not exactly suited for what we are looking for. Applying this algorithm on the two strings S=“yxxabcd” and T=“abcdxbcd” will produce the table shown in FIG. 4A. The back tracking algorithm traversing the colored cells will reconstruct two longest alignments: “x” and “bcd” as one solution, as shown in FIG. 4B, and “abcd” as another solution, as shown in FIG. 4C (there are other alignments for these strings which are not shown). There is a clear advantage of the second solution over the first one, since it uses a single common substring rather than two in the first solution. However, the traditional algorithm does not distinguish between these two alignments. Our problem is thus modified to finding the maximum alignment which uses the minimum number of blocks, and the algorithm which computes it (thus finding only the second solution for the example of FIG. 4), is shown in FIG. 5.

Given S=s₁•s₂ • • • sₙ and T=t₁•t₂ • • • tₘ, a matrix A of size (n+1)×(m+1), which suits the lengths of source file S and target file T, is used. First column cells of the matrix are initialized, at step 502, by i, where i stands for their row index, to indicate i character deletions for converting S to T. First row cells are initialized, at step 503, by j, where j refers to their column index, to indicate j character insertions for converting S to T. This is done by using the following formulations, for example: ∀0≦i≦n A[i,0]←i; ∀0≦j≦m A[0,j]←j, where i goes over all rows of the matrix and j goes over all columns of the matrix. A[i,0] refers to cells in the matrix corresponding to column “0” (the first column), and A[0,j] refers to row “0” of the matrix (i.e., the first row). After the matrix is initialized, the computation proceeds by moving through all rows of the matrix, at steps 504, 506 and 510, and progressing through all columns at the current row, at steps 508, 512 and 530, in parallel to scanning the source string within the file S and the target string within the target file T. Each row corresponds to a different character of the source string (at steps 504 and 510), and each column of the matrix corresponds to a character of the target string (at steps 508 and 530). At steps 518, 522 and 524 (FIG. 5B), each cell A[i,j], in the matrix A is assigned the value of the minimum of:
The value in the diagonal cell A[i−1,j−1] in case of a match between sᵢ and tⱼ, and a match between sᵢ₋₁ and tⱼ₋₁, where sᵢ is the i^{th} character of S, tⱼ is the j^{th} character of T, sᵢ₋₁ is the i−1^{th} character of S, and tⱼ₋₁ is the j−1^{th} character of T; (at step 522)
“1” plus the value in the diagonal cell A[i−1,j−1] in case of a match between sᵢ and tⱼ, and a mismatch between sᵢ₋₁ and tⱼ₋₁, where sᵢ is the i^{th} character of S, tⱼ is the j^{th} character of T, sᵢ₋₁ is the i−1^{th} character of S, and tⱼ₋₁ is the j−1^{th} of T; (at step 524)
an horizontal gap, by referring to “1” plus the value in the preceding row cell A[i−1,j] (character deletion); (at steps 518, 522 and 524)
a vertical gap, by referring to “1” plus the value in the preceding column cell A[i,j−1] (character insertions); (at steps 518, 522 and 524)

At step 522, which is performed if there is a match between the current character sᵢ of the source string and the current character tⱼ of the target string (the match that is prior determined at step 516), and there is a match between the previous character sᵢ₋₁ of the source string and the previous character tⱼ₋₁ of the target string (the match that is prior determined at step 520), the following formula is used: A[i,j]←min(A[i−1,j]+1, A[i,j−1]+1, A[i−1][j−1]) which relates to the minimum value between “1” plus the value in the preceding row cell (A[i−1,j]+1), “1” plus the value in the preceding column cell (A[i,j−1]+1), and the preceding diagonal cell (A[i−1][j−1]). It should be noted that step 518 is performed if there isn't a match between the current character sᵢ of source string and the current character tⱼ of the target string (the match that is prior determined at step 516), and the formula used is A[i,j]←min(A[i−1,j]+1, A[i,j−1]+1), which relates to the minimum value between “1” plus the value in the preceding row cell (A[i−1,j]+1) and “1” plus the value in the preceding column cell (A[i,j−1]+1). Step 524 is performed if there is a match between the current character sᵢ of source string and the current character tⱼ of the target string (the match that is prior determined at step 516), and there isn't a match between the previous character sᵢ₋₁ of source string and the previous character tⱼ₋₁ of the target string (the match that is prior determined at step 520), and the formula used is A[i,j]←min(A[i−1,j]+1, A[i,j−1]+1, A[i−1][j−1]+1), which relates to the minimum value between “1” plus the value in the preceding row cell (A[i−1,j]+1), “1” plus the value in the preceding column cell (A[i,j−1]+1), “1” plus the value in the preceding diagonal cell (A[i−1][j−1]+1).

Back to FIG. 5A, at step 532, the minimum number of operations required in order to transform S into T is attained in the last cell of the matrix, A[n,m] (where n and m suit the lengths of source file S and target file T, respectively).

The difference between the algorithm presented in FIG. 5 and the one presented in FIG. 3 is that in FIG. 5 a diagonal penalty is applied. Each time an alignment occurs, there is an opening charge. Whenever a match occurs between a character of S (sᵢ) and a character of T (tⱼ) this condition is verified by checking whether the corresponding former characters do not match. This way the minimum edit distance with minimum number of gaps is attained.

The implementation of the dynamic programming algorithm presented in FIGS. 4 and 5 is memory consuming, and suffers from hardware limitations. For example, the dynamic programming table for two files of about 100K bytes each, requires at least 10¹⁰ bytes (assuming each cell occupies a single byte which is definitely a lower-bound). In order to handle addresses of sizes more than 4 Gbytes, 64-bit OS must be used since a 32-bit OS is limited to 2³²=4 GB. For a straight forward implementation of the dynamic programming algorithms applied on this example, the computer must have at least 10 Gbytes of physical memory for storing the dynamic programming table. To overcome the problem we use the fact that the operations of the algorithm are done on neighboring cells; the diagonal cell, the cell to the left and the cell above. Thus only a constant number of rows can be stored in the RAM, and all other rows can be saved on external storage devices. A set of cells are then fetched and dumped from and to the main memory. Saving computational time is achieved by minimizing the number of reloads and dumps and processing the maximum possible number of rows bounded by the size of the RAM.

According to the prior art, Masek et al. present (in the article titled “A faster algorithm for computing string edit distances”, in the journal of Comput. Syst. Sci., volume 20, pages 18-31, 1980) a sub-quadratic global alignment string comparison algorithm based on the Four Russians paradigm (in the article titled “On Economical Construction of the Transitive Closure of an Oriented Graph”, Soviet Math. Dokl. Vol. 11, pages 1209-1210, 1970), which divides the dynamic programming table into uniform sized (log n×log n and O(ⁿ^{²}/_{log n}). Also, Chrochemore et al. (in the article titled “A Sub-quadratic Sequence Alignment Algorithm for Generalized Cost Metrics”, in SIAM Journal of Computing, 32(6), pages 1654-1673, 2003) describe an O(^{hn}^{²}/_{log n}) algorithm, where h denotes the entropy of the strings, being relatively faster than the above algorithm presented by Masek et al. It should be noted that, according to an embodiment of the present invention, even that encoding is done only once, a greedy linear time heuristic is applied, rather than a dynamic programming approach, even when obtaining a sub-quadratic time performance.

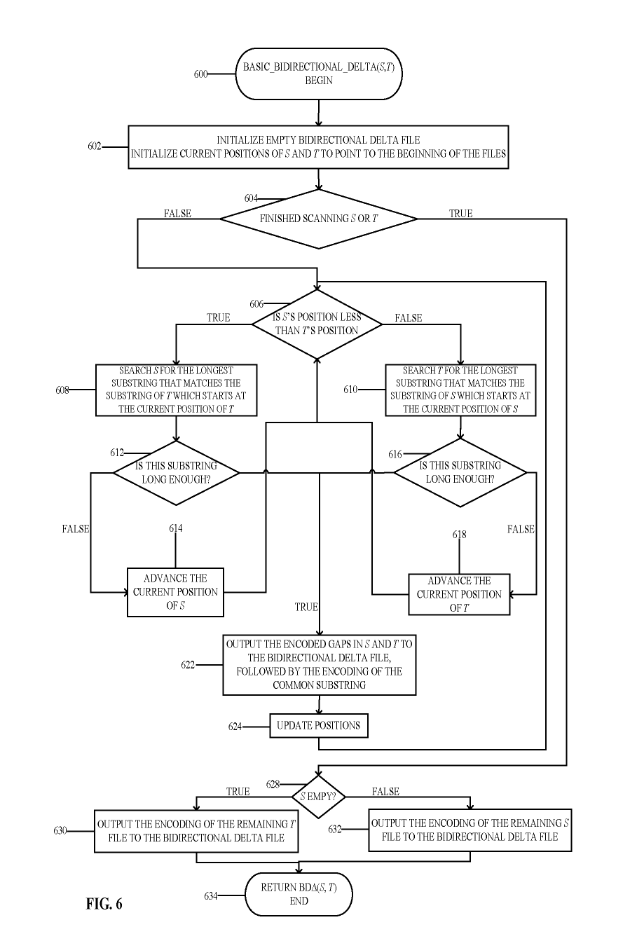

FIG. 6 is a schematic flow-chart of constructing a bidirectional delta file for given source file S and target file T, according to an embodiment of the present invention. According to this embodiment, given two strings S=s₁•s₂ • • • sₙ of n characters and T=t₁•t₂ • • • tₙ, of m characters, where sᵢ and tⱼ are characters from some alphabet, the notation s[i,j] can be used for representing the source substring/string sᵢ•sᵢ₊₁ • • • s₁ of source file S, and analogically, the notation t[i,j] can be used for representing the target substring/string tᵢ•tᵢ₊₁ • • • tⱼ of target file T. At step 600, the execution of function BASIC_BIDIRECTIONAL_DELTA( ) is initiated, thereby initiating the process of constructing a bidirectional delta file for given source file S and target file T. At step 602, an empty bidirectional delta file is initialized by BDΔ(S, T)←ε, where ε denotes an empty file. The current positions (locations) of substring within source files S and T are also initialized to point to the beginning of the files. By denoting the current position of source substring by i and the current position of target substring by j, this is done by initializing i and j by “0”. Assistance indices, iold and jold, are used for saving the starting position of the next portion to be encoded in S and T files, respectively, and are initialized by “0”. Therefore, at step 602, the following instructions are performed: BDΔ(S, T)←ε; i←0; j←0; iold←0; and jold←0, wherein BDΔ(S,T) is a bidirectional delta file.

The aligned blocks are found by a synchronized parsing of the strings from left to right. At step 604, source and target files (S and T, respectively) are scanned in parallel by either checking whether the position of S precedes the position (location) of T (as further done at step 606), or by determining whether the remaining portion of S is longer than the remaining portion of T. The second alternative is done by subtracting the current position i from the length of S (which was denoted previously by n) and comparing it to the result of subtracting the current position j from the length of T (which was denoted previously by m). Returning to the first alternative, if the position of S precedes the position of T (as determined at step 606), then the next common substring of S and T is determined at step 608 by searching S for the longest (or any other predefined length) substring that matches the substring of T, which starts at the current position j of T. Otherwise, at step 610, the next common substring is determined by searching T for the longest substring that matches the substring of S, which starts at the current position i of S. This can be done, for example, by using a function (method/algorithm) named CS( ) which is applied on two strings, X and Y, and returns an ordered pair, where the first component is the index of the starting position of a substring in Y, which matches the longest (or any other predefined length) prefix of X, and the second component is its length. For example, CS(abcdxxx, xyzabcdyyabcdx)=(9,5) since the longest occurrence of a prefix of X in the second component string is at its ninth position, and refers to the string abcdx, which consists of 5 characters. It should be noted that this method is not symmetric, and CS(X,Y) is not necessarily equal to CS(Y,X). Thus, step 608, which is used for searching for the next aligned block, is done by performing the statement (formulation)

(inew,len)←CS(t[j,m],s[i,n]), i.e., calling the CS( ) method with the remaining portions of T and S (as defined above, t[j,m] can be used for representing the substring/string tⱼ•tⱼ₊₁ • • • tₘ of T, which is in this case a suffix of T and s[i,n] can be used for representing the source substring/string sᵢ∩sᵢ₊₁ • • • sₙ, of source file S, which is in this case a suffix of S).

The CS( ) method returns an ordered pair (inew,len), where inew, is the starting index in S where the common substring was found (the index j is the starting position of that common substring in T), and len is the length of the common substring. Step 610 is done by performing the statement (jnew,len)←CS(s[i,n],t[j,m]), i.e., calling the CS( ) method with the remaining portions of S (s[i,n] and T t[j,m]), which returns an ordered pair (jnew,len), where jnew the starting index in T wherein the common substring was found (the index i is the starting position of that common substring in source file S), and len is the length of the common substring. The length, len, of the common substring found by the CS( ) method is compared against a supplied parameter, at steps 612 and 616, to justify the use of this aligned block by checking whether the common substring is long enough. If the length is less than a predefined parameter Minlen, the method CS( ) is applied on the following position of S or T (at steps 614 or 618, and back to step 606). Otherwise, the gaps in both files are encoded using self-pointers, i.e., pointers copying substrings to the current position in the file from the already scanned portion of the same file.

According to an embodiment of the present invention, the format of the bidirectional file BDΔ(S,T) is composed out of flag bits, pointers to aligned blocks, and LZSS items of S and T, where LZSS items also include flag bits of their own, and are either pointers to previous occurring strings or raw characters. Thus, for example, three flag bits can be required to distinguish between such items in BDΔ(S,T), for which LZSS items require 2 additional inner flag bits to differentiate pointers from raw characters. For simplicity, we can for example ignore the inner implementation of the LZSS components (since pointers are given as ordered pairs and raw characters are written explicitly) and only use the flag bits in BDΔ(S,T) that can be referred as “1”, “2” and “3”, respectively, for:
aligned blocks;
LZSS S-items (LZSS item in source file S); and
LZSS T-items (LZSS item in target file T).

The LZSS implementation then uses two flag bits to differentiate self pointers and raw characters. An aligned block is represented by a “1” flag bit, and followed by a triple (Sadd, Tadd, len) for referring to the common substring that occurs in S at address Sadd, and in T at address Tadd, and the number of characters is len. Alternatively, the quadruplet (1, Sadd, Tadd, len) is used instead of the “1” flag bit followed by the triplet (Sadd, Tadd, len). The items of the encoded gaps can be inserted in between the encodings of the corresponding common substring in any order (e.g., alternating LZSS S-items and LZSS T-items), as long as decompressing LZSS S-items in the order they are given—generates S, and decompressing the LZSS T-items in the order they are given—generates T. For simplicity, LZSS S-items are inserted before LZSS T-items in each gap. Thus, at step 622 the following three issues are performed (concatenated) in case the previous step was 612, and then the result is outputted to the bidirectional delta file:
The gap in S between the previous block that ends at position iold, and the new block that starts at position inew is encoded using LZSS and prefixed by the flag bit “2”;
The gap in T between the previous block that ends at position jold, and the new block that starts at position j is encoded using LZSS and prefixed by the flag bit “3”;
The positions in S and T of the aligned block, and the length of the block prefixed by the flag bit “1”.

According to an embodiment of the present invention, the symbol “•” is used for denoting the concatenation, and the following operations are performed in step 622 in case 612 was the previous step:

BDΔ(S,T)←BDΔ(S,T)•2•LZSS(s[iold,inew])

BDΔ(S,T)←BDΔ(S,T)•3•LZSS(t[jold,j])

BDΔ(S,T)←BDΔ(S,T)•1•(inew,j,len)

LZSS(s[iold, inew]) applies the LZSS compression scheme on the string s[iold, inew], which is a substring of S starting at position “iold” and ending at position “inew”; i.e., the substring/string s_{iold}•s_{iold+1} • • • s_{inew} of source file S. LZSS(t[jold,j]) applies to the LZSS compression scheme on the string t[jold,j] which is a substring of T starting at position jold and ending at position “j”; i.e., the substring/string t_{jold}•t_{jold+1} • • • tⱼ of source file T. The triplet (inew, j, len) refers to the common substring of S and T that starts at position “inew” of S and position “j” of T and the number of characters of this common substring is “len”.

Thus, at step 622, in case step 616 was the previous step, the following three issues are performed (concatenated), and then the result is outputted to the bidirectional delta file:
The gap in S between the previous block that ends at position iold, and the new block that starts at position i is encoded using LZSS and prefixed by the flag bit “2”;
The gap in T between the previous block that ends at position jold, and the new block that starts at position jnew is encoded using LZSS and prefixed by the flag bit “3”;
The positions in S and T of the aligned block, and the length of the block prefixed by the flag bit “1”.

The following statements are therefore performed in step 622, in case 616 was the previous step:

BDΔ(S,T)←BDΔ(S,T)•2•LZSS(s[iold,i])

BDΔ(S,T)←BDΔ(S,T)•3•LZSS(t[jold,jnew])

BDΔ(S,T)←BDΔ(S,T)•1•(i,jnew,len)

LZSS(s[iold, i]) applies the LZSS compression scheme on the string s[iold, i], which is a substring of S starting at position “iold” and ending at position “i”; i.e., the substring/string s_{iold}•s_{iold+1} • • • sᵢ of source file S. LZSS(t[jold,jnew]) applies the LZSS compression scheme on the string t[jold,jnew], which is a substring of T starting at position “jold” and ending at position “jnew”; i.e., the substring/string t_{jold}•t_{jold+1} • • • t_{jnew} of source file T. The triplet (i, jnew, len) refers to the common substring of S and T that starts at position “i” of S and position “jnew” of T and the number of characters of this common substring is “len”.

At step 624, the current and assistant positions in S and T (i.e., iold, inew, jold and jnew) are updated to point (just) after the common block. The indices i and j pointing to the current location in S and T are advanced by performing the following operations:

i←i+len; j←jnew+len; if i and jnew are the positions of the aligned block, or
i←inew+len; j←j+len; if inew and j are the positions of the aligned block. The indices iold and jold, which save the starting positions of the next substrings to be encoded are also updated to save the new values of i and j by iold←i; jold←j; so that the search continues (just) after the common substring. Thus, The following statements (formulations) are performed: i←inew+len; j←j+len; iold←i; jold←j; in case 608 was applied, or the statement i←i+len; j←jnew+len; iold←i; jold←j; in case 610 was applied.

When the scanning of one of S or T files is finished (at step 604 followed by step 628), then the remaining portion of the other file (T or S, respectively) is compressed by using the conventional LZSS algorithm, and then outputted to the bidirectional delta file BDΔ(S,T), at steps 630 and 632. At step 630, the encoding of the remaining T file is concatenated to the bidirectional delta file, preceded by the flag bit “3”, by performing the statement: BDΔ(S,T)←BDΔ(S,T)•3•LZSS(t[jold, m]). At step 632, the encoding of the remaining S file is concatenated to the bidirectional delta file, preceded by the flag bit “2”, by performing the statement: BDΔ(S, T)←BDΔ(S, T)•2•LZSS(s[iold, n]). Finally, the method is terminated at step 634, where the bidirectional delta file is constructed.

It should be noted that the CS( ) method used in the BASIC_BIDIRECTIONAL_DELTA( ) function (method) can be implemented in linear time, i.e. the asymptotic upper bound for the time it requires is proportional to the size of the input, which is sum of lengths of S and T (denoted here by n and m parameters). The linear time processing time is achieved by using a suffix trie (comes from the word “retrieval”) for the string S•T$, where $ is a character not belonging to the original alphabet of S and T. Every node ν of a regular trie is associated with a string, which is obtained by concatenating, top down, the labels on the edges forming the path from the root to node ν. The suffix trie can be, generally, a compact trie, i.e., each path of single child nodes is collapsed to its starting and ending node, with an edge labeled with a string that is a concatenation of all labels on the original path, so that each non-leaf node (except the root that might be a single child node) has at least two children. The set of strings associated to its leaves is the set of the suffixes of S•T$. Since the $ character does not occur elsewhere in S or T, each suffix corresponds to a unique leaf. Therefore, a node with descendant nodes, which refer to substrings with prefixes from S and T, corresponds to common substrings. As described above, the CS( ) method is applied on two strings, X and Y, and returns the index of the starting position of a substring in Y, which matches the longest (or any other predefined length) prefix of X. It is done by traversing the suffix trie with the string X, starting at its root. The deepest node in the suffix trie on this path from the root having such descendents correspond to the longest common substring of X and Y, and any other node having such descendents correspond to any other predefined length of a common substring of X and Y, and, thus, can be found in time proportional to its length. It should be noted that CS( ) can be implemented using hashing, having better processing time, while not necessarily locating the longest match.

For example, the following substrings can be considered, in S and T files, respectively: S=“xxxabcdefxablmn” and T=“abcdxyzlmnxxx”.

Using flag bits BP and OP as defined above, the forwards and backwards delta files are Δ(S,T)=(BP,3,4)xyz(BP,12,3)(BP,0,3) and Δ(T,S)=(BP,10,3)(BP,0,4)ef(OP,7,3)(BP,7,3).

The delta file of T with respect to S, Δ(S,T), is a concatenation of the triplet (BP,3,4), which is used for copying the string “abcd” of 4 characters from location “3” of source file S (starting from “0”), followed by three raw characters, “xyz”, possibly farther encoded, followed by the triplet (BP,12,3), used for copying the string “lmn” of 3 characters from location “12” of source file S, followed by (BP,0,3) for copying the string “xxx” of 3 characters from location “0” of S. The delta file of S with respect to T, Δ(T,S), is a concatenation of the triplet (BP,10,3), which is used for copying the string “xxx” of 3 characters from location “10” of file T (starting from “0”), followed by the triplet (BP,0,4) used for copying the string “abcd” of 4 characters from location “0” of file T, followed by two raw characters, “ef”, possibly farther encoded, followed by the triplet (OP,7,3) for copying the string “xab” of 3 characters from 7 characters before the current location in S, followed by (BP,7,3) for copying the string “lmn” of 3 characters from location “7” of T.

By applying the method presented in FIG. 6, two aligned blocks are determined by the CS( ) method, i.e. “abcd” and “lmn”, and are encoded by (1,3,0,4) and (1,12,7,3), respectively, where “1” is a flag bit. The gaps between these common substrings (including the substrings at both ends of the strings) are encoded by using the LZSS algorithm. The gaps of S are encoded by (2,x)(2,x)(2,x) for the first gap “xxx” (“2” is a flag bit), and (2,e)(2,f)(2,7,3) for the second gap efxab (it should be noted that the first coordinate of the triplet (2,7,3) is a flag bit for a S-LZZS item, “7” is the offset of the second occurrence of xab to its previous occurrence, and “3” is its length). The first gap of T is encoded by (3,x)(3,y)(3,z) for “xyz” and by (3,x)(3,x)(3,x) for the last gap of T, “xxx”. The output bidirectional delta file BDΔ(S,T) can be therefore defined by the following formulation:

BDΔ(S,T)=(2,x)(2,x)(2,x)(1,3,0,4)(2,e)(2,f)(2,7,3)(3,x)(3,y)(3,z)(1,12,7,3)(3,x)(3,x)(3,x).

Also, it should be noted that the above substring “xxx”, even though being a common substring of S and T, is encoded as individual characters in both LZSS encodings of the bidirectional delta file. This loss in compression may be due to the fact that only aligned common substrings are relatively efficiently encoded. An improved version of the basic bidirectional delta encoding algorithm (method), denoted as NON_ALIGNED_BD( ) for example, suggests using a regular delta encoding instead of the LZSS encoding used in the BASIC_BIDIRECTIONAL_DELTA( ) method presented in FIG. 6.

FIG. 7 is a schematic flow chart of constructing a bidirectional delta file for given source file S and target file T, according to another embodiment of the present invention. FIG. 7 presents an execution of the NON_ALIGNED_BD( ) function for allowing pointers to non-aligned common substrings to be relatively efficiently encoded, according to an embodiment of the present invention. The files are scanned in parallel by keeping the pointers to both files synchronized the same way as in FIG. 6. Unlike the LZSS method used in the aligned bidirectional algorithm, here a delta encoding is applied. Δ(X, Y) is used as a delta compression scheme which is applied on the strings X and Y, where X is a substring of the source file S, and Y is a substring of the target file T. This way, also non aligned blocks are compressed using the help of the alternative file. This comes at the price of having three different formats of items in the delta encoding (i.e., pointers to the source file, self pointers, and raw characters) as opposed to only two different formats in the conventional LZSS encoding (i.e., self pointers and raw characters). Returning to our last example, the substring “xxx” of the first gap of S is, therefore, encoded as (2,BP,10,3) for copying it from the 10^{th} position of T, and is replaced by the triple (3,BP,0,3) in the last gap of T, for copying it from the beginning of S. Thus, the output bidirectional delta file BDΔ(S,T) can be defined by the following formulation:

BDΔ(S,T)=(2,BP,10,3)(1,3,0,4)(2,e)(2,f)(2,OP,7,3)(3,x)(3,y)(3,z)(1,12,7,3)(3,BP,0,3).

As in the previous BASIC_BIDIRECTIONAL_DELTA method presented in FIG. 6, the NON_ALIGNED_BD( ) method is used for constructing a bidirectional delta file for given source and target files S and T, respectively. At step 702, an empty bidirectional delta file is initialized by BDΔ(S, T)←ε, where ε denotes an empty file. The current positions of S and T are also initialized to point to the beginning of the files. By denoting the current position of S by i and the current position of T by j, this is done by initializing i and j by “0”. Assistance indices, iold and jold, are used for saving the starting position of the next portion to be encoded in S and T, respectively, and are initialized by “0”. At step 702, therefore, the following instructions are performed:

BDΔ(S,T)←ε; i←0; j←0; iold←0; and jold←0.

According to an embodiment of the present invention, the aligned blocks are determined by a synchronized parsing of the strings from left to right. S and T are scanned in parallel by either checking whether the position of S precedes the position of T (as done at step 706), or by checking whether the remaining part of source file S is longer than the remaining portion of target file T. The second alternative is done as defined earlier. The first alternative is done by checking if the position of S precedes the position of T (as determined at step 706), then the next common substring is determined, at step 708, by searching source file S for the longest (or any other predefined length) substring that matches the substring of T, which starts at the current position j of T. Otherwise, at step 710, the next common substring is found by searching T for the longest substring that matches the substring of S, which starts at the current position i of S. It should be noted that this can be performed in substantially the same way as presented in the BASIC_BIDIRECTIONAL_DELTA method of FIG. 6, by using the CS( ) method. Thus, step 708, which is used for searching for the next aligned block, is done by performing the operations (inew,len)←CS(t[j,m],s[i,n]), i.e., calling the CS method with the remaining portions of T (t[j,m]) and S (s[i,n]), which returns an ordered pair (inew,len), where inew, is the starting index in S where the common substring was found (the index j is the starting position of that common substring in T), and len is the length of the common substring. At step 710 the statement (jnew,len)←CS(s[i,n],t[j,m]) is performed, i.e., calling the CS( ) method with the remaining portions of S (s[i,n] and T t[j,m]), which returns an ordered pair (jnew,len), where jnew the starting index in T wherein the common substring was found (the index i is the starting position of that common substring in source file S), and len is the length of the common substring. The length, len, of the common substring found by the CS( ) method is compared against a supplied parameter, at steps 712 and 716, to justify the use of this aligned block by checking whether the common substring is long enough. If the length is less than a predefined parameter Minlen, the method CS( ) is applied on the following position of S or T (at steps 714 or 718, and back to step 706). Otherwise, the gaps in both files are encoded using self-pointers, pointers into the alternative file, and raw characters, by using any delta encoding algorithm. The delta encoding of the gaps of S and T are then outputted to the bidirectional delta file, followed by the encoding of the common substring itself (at step 722). In this case, the format of the bidirectional file is composed out of flag bits, pointers to aligned blocks, and delta items of S and T, which, in turn, include flag bits, pointers to the alternative file, self pointers and raw characters. As in FIG. 6, the three flag bits are used to distinguish between items in the bidirectional delta file BDΔ(S,T). The delta items require three additional inner flag bits to differentiate copies from the base file, self pointers and raw characters. As before, a flag bit of a copy from the base file is denoted by BP (Base Pointer flag bit), and a copy from the target file itself is denoted by OP (Offset Pointer flag bit), while raw characters are given explicitly. Formally, flag bits “1”, “2” and “3”, are used, respectively, for
aligned blocks;
delta S-items; and
delta T-items.

According to an embodiment of the present invention, an aligned block is represented by a quadruplet (1, Sadd, Tadd, len), where “1” is an aligned block flag bit, Sadd is the starting address of the aligned block in S, Tadd is the starting address of the aligned block in T, and length is the number of its characters. As in FIG. 6, the items of the encoded gaps can be inserted in between the encodings of the corresponding common substring in any order, as long as they occur in the same order as in the delta encoding for S and T. For simplicity, delta S-items are inserted before delta T-items in each gap. Thus, at step 722, in case 712 was the previous step, the following three issues are concatenated, and then the result is outputted to the bidirectional delta file BD Δ(S,T)
The gap in source file S between the previous block that ends at position iold, and the new block that starts at position inew is encoded using delta encoding and prefixed by the flag bit “2”;
The gap in target file T between the previous block that ends at position jold, and the new block that starts at position j is encoded using delta encoding and prefixed by the flag bit “3”.
The positions in S and T of the aligned block, and the length of the block prefixed by the flag bit “1”.

According to an embodiment of the present invention, the sign “•” is used for denoting the concatenation, and the following operations are performed in step 722 in case 712 was the previous step:

BDΔ(S,T)←BDΔ(S,T)•2•Δ(s[iold,inew],T)

BDΔ(S,T)←BDΔ(S,T)•3•Δ(t[jold,j],S)

BDΔ(S,T)←BDΔ(S,T)•1•(inew,j,len)

Δ(s[iold, inew],T) applies a delta compression scheme on the strings s[iold, inew] and T, where s[iold, inew] is a substring of S starting at position “iold” and ending at position “inew”, i.e., the substring/string s_{iold}•s_{iold+1} • • • s_{inew} of source file S. Δ(t[jold, j],S) applies a delta compression scheme on the strings t[jold, j] and S where t[jold, j] is a substring of T starting at position “jold” and ending at position “j”, i.e., the substring/string t_{jold}•t_{jold+1} • • • tⱼ of target file T. The triplet (inew, j, len) refers to the common substring of S and T that starts at position “inew” of S and position “j” of T and the number of characters of this common substring is “len”.

At step 722, in case step 716 was the previous step, the following three issues are concatenated, and then the result is outputted to the bidirectional delta file BDΔ(S,T)
The gap in source file S between the previous block that ends at position iold, and the new block that starts at position i is encoded using delta encoding and prefixed by the flag bit “2”;
The gap in target file T between the previous block that ends at position jold, and the new block that starts at position jnew is encoded using delta encoding and prefixed by the flag bit “3”.
The positions in S and T of the aligned block, and the length of the block prefixed by the flag bit “1”.

This is done at step 722, in case 716 was the previous step, using the statements:

BDΔ(S,T)←BDΔ(S,T)•2•Δ(s[iold,i],T)

BDΔ(S,T)←BDΔ(S,T)•3•Δ(t[jold,jnew],S)

BDΔ(S,T)←BDΔ(S,T)•1•(i,jnew,len)

Δ(s[iold, i],T) applies a delta compression scheme on the strings s[iold, i] and T, where s[iold, i] is a substring of S starting at position “iold” and ending at position “i”, i.e., the substring/string s_{iold}•s_{iold+1} • • • sᵢ of source file S. Δ(t[jold, jnew],S) applies a delta compression scheme on the strings t[jold, jnew] and S, where t[jold, jnew] is a substring of T starting at position “jold” and ending at position “jnew”, i.e., the substring/string t_{jold}•t_{jold+1} • • • t_{jnew} of source file T. The triplet (i, jnew, len) refers to the common substring of S and T that starts at position “i” of S and position “jnew” of T and the number of characters of this common substring is “len”.

At step 724, the current and assistant positions (i.e., iold, inew, jold and jnew) in S and T are updated to point (just) after the common block. The indices i and j pointing to the current location in S and T are advanced by performing the following operations i←i+len; j←jnew+len; if i and jnew are the positions of the aligned block, or i←inew+len; j←j+len; if inew and j are the positions of the aligned block. The indices iold and jold which save the starting positions of the next substrings to be encoded are also updated to save the new values of i and j by iold←i; jold←j; so that the search continues right after the common substring. The following statements (formulations) are performed: i←inew+len; j←j+len; iold←i; jold←j; in case 708 was applied, or the statement i←i+len; j←jnew+len; iold←i; jold←j; in case 710 was applied.

When the scanning of one of the files S or T is finished (at step 704 followed by 728), the remaining portion of the other file (S or T, respectively) is compressed by using delta encoding, and then outputted to the bidirectional delta file BDΔ(S, T) (at steps 730 and 732). At step 730, the delta encoding of the remaining T file is concatenated to the bidirectional delta file, preceded by the flag bit “3”, by performing:

BDΔ(S,T)←BDΔ(S,T)•3•Δ(t[jold,m],S).

At step 732, the delta encoding of the remaining S file is concatenated to the bidirectional delta file, preceded by the flag bit “2”, by performing:

BDΔ(S,T)←BDΔ(S,T)•2•Δ(s[iold,n],T).

Finally, the method is terminated at step 534, where the bidirectional file BDΔ(S, T) is constructed.

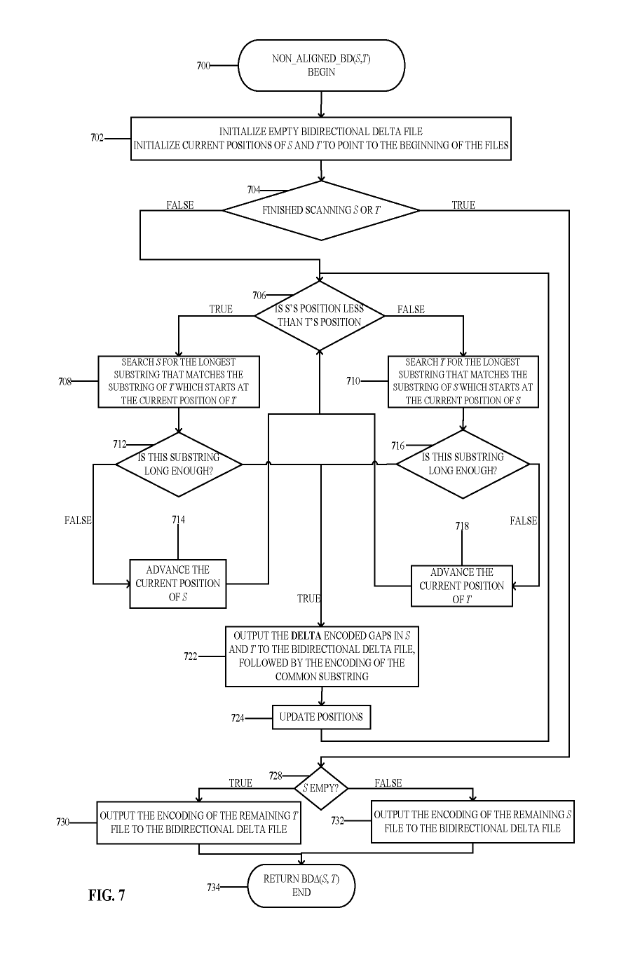

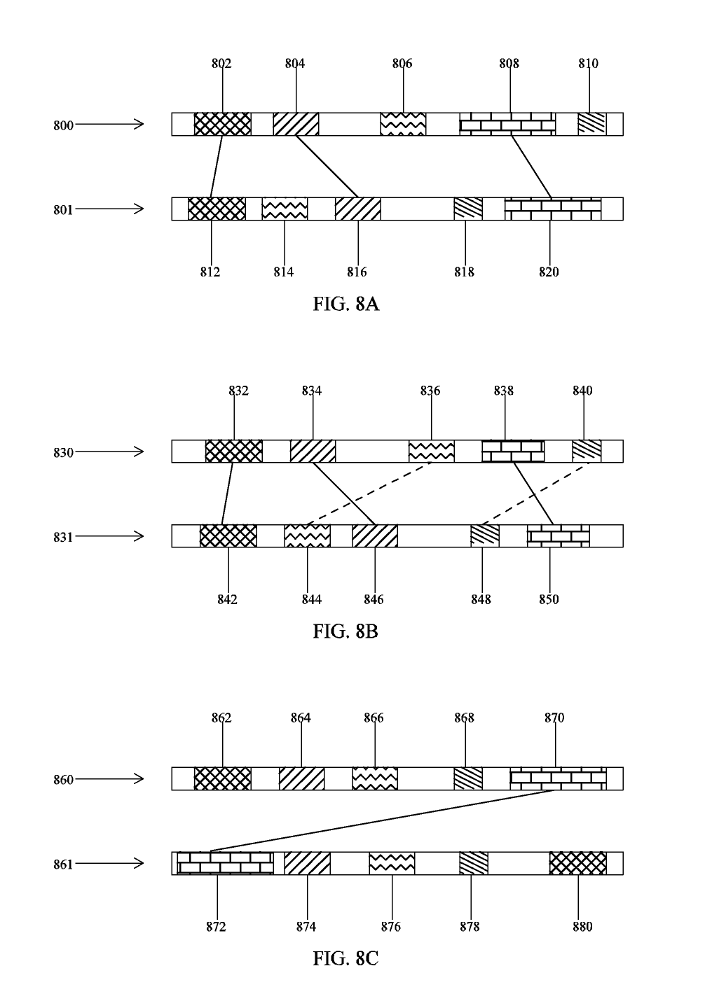

FIGS. 8A and 8B are schematic illustrations, which visually represent differences between BASIC_BIDIRECTIONAL_DELTA and NON_ALIGNED_BD functions (methods), presented in FIGS. 6 and 7, respectively, according to an embodiment of the present invention. In addition, FIG. 8C is a schematic illustration of a case, which may be desired to be avoided when using the BASIC_BIDIRECTIONAL_DELTA and NON_ALIGNED_BD methods of FIGS. 6 and 7, respectively, according to an embodiment of the present invention. In FIGS. 8A to 8C, the source file S and target file T are presented such that S is denoted as 800, 830 and 860, respectively, and T is denoted as 801 and 831, 861, respectively. Common substrings of S and T have the same texture (802 and 812; 804 and 816; 806 and 814; 808 and 820; 810 and 818; 832 and 842; 834 and 846; 836 and 844; 838 and 850; 840 and 848; 862 and 880; 864 and 874; 866 and 876; 868 and 878; and 870 and 872). In the BASIC_BIDIRECTIONAL_DELTA method of FIG. 6, only aligned blocks are used as pointers to the alternative file (such as aligned blocks 802 and 812; 804 and 816; and 808 and 820). The gaps, between the aligned blocks are encoded by pointing backward to previous occurring substrings in the same file. On the other hand, in the NON_ALIGNED_BD method of FIG. 7, non-aligned blocks are also used as pointers to the alternative file (for example aligned blocks can be 832 and 842; 834 and 846; 838 and 850; and non-aligned blocks can be 836 and 844; 840 and 848). The remaining portions of the source and target files are encoded by pointing backwards to previous occurring substrings in the same file.

FIG. 8C presents a relatively rare case, for which the composed bidirectional delta file may relatively suffer from compression inefficiency. In this example, the first common block selected by the CS( ) algorithm occurs in opposing ends of the files (870 and 872, respectively). As a result, the resulting set of aligned block consists of a single common substring. Since the compression savings of a bidirectional delta file over conventional prior art delta files (backwards and forwards delta files) is due to using a single copy of the aligned blocks, the resulting bidirectional file according to FIG. 8C may be relatively inefficient. Thus, the aligned blocks 864 and 874, 866 and 876, and 868 and 878, can be selected to better utilize the similarity of the two given files. As already mentioned, in order to distinguish between aligned and non-aligned blocks, a flag bit can be required for substantially all items of the encoded file. The effect, therefore, of a single aligned block as compared to several aligned blocks, results in a relatively inefficient bidirectional delta file. According to an embodiment of the present invention, comparing the bidirectional delta file to the corresponding prior art forwards and backwards delta files, the advantage of said bidirectional delta file in this case is referring only once to this single aligned block. However, the remaining items in the bidirectional delta file use more flag bits than the items in the forwards and backwards delta files (the bidirectional delta file uses 3 flag bits to differentiate aligned blocks, S-items and T-items in addition to the flag bits, which are also used in a regular delta file). It should be noted that in order to avoid cases of skipping aligned blocks (e.g., blocks 864 and 874; 866 and 876; and 868 and 878), the NON_ALIGNED_BD method of FIG. 7 suggests using heuristics that control the distance between the corresponding positions in the source and target files. An aligned block can be selected only if its length is proportional to its distance.

It should be noted that according to an embodiment of the present invention, is provided a system (device/apparatus) configured to perform (process) the methods of the present invention, such as the methods illustrated in FIGS. 5 to 7. For this, the system (device/apparatus) of present invention comprises corresponding units/components and means, which can be either hardware and/or software units/components.

In addition, it should be noted that according to an embodiment of the present invention, the methods of the present invention (e.g., the methods presented in FIGS. 5 to 7) can be performed by executing a program of instructions tangibly embodied within a program storage device/system readable by machine, such as a computer.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

What is claimed is:

1. A method of generating an encoded bidirectional delta file to be used for reconstructing target and source files by decoding said bidirectional delta file, each of said target and source files comprising one or more substantially identical substrings, where each of said substrings is encoded within said bidirectional delta file by using a single pointer, wherein the steps of encoding and decoding a bidirectional delta file are performed and implemented in any of
a) computer hardware, and
b) computer software embodied in a physically-tangible, non-transitory, computer-readable medium.

2. The method according to 1, wherein the target file is reconstructed by using the source file and the bidirectional file.

3. The method according to 1, wherein the source file is reconstructed by using the target file and the bidirectional file.

4. The method according to 1, further comprising determining the substantially identical substring within each one of the target and source files by searching said target and source files.

5. The method according to 4, wherein the substantially identical substring is the substring having a predefined length, said substring determined when starting searching the target and source files from a corresponding location within said target and/or source files.

6. The method according to 5, further comprising continuously updating the corresponding location within the target and source files.

7. The method according to 1, further comprising adding at least one flag bit to each of the substantially identical substrings.

8. The method according to 1, wherein the substantially identical substring is an aligned substring.

9. The method according to 1, wherein the substantially identical substring is a non-aligned substring.

10. The method according to 1, wherein the substantially identical substring is a self-pointer.

11. The method according to 1, further comprising compressing the bidirectional delta file by using at least one compression method.

12. A system configured to generate an encoded bidirectional delta file to be used for reconstructing target and source files by decoding said bidirectional delta file, each of said target and source files comprising one or more substantially identical substrings, where each of said substrings is encoded within said bidirectional delta file by using a single pointer, wherein the bidirectional delta encoder and the bidirectional delta decoder are implemented in any of
a) computer hardware, and
b) computer software embodied in a physically-tangible, non-transitory, computer-readable medium.

13. A program storage device readable by machine, tangibly embodying a program of instructions executable by the machine to perform a method of generating an encoded bidirectional delta file to be used for reconstructing target and source files by decoding said bidirectional delta file, each of said target and source files comprising one or more substantially identical substrings, wherein each of said substrings is encoded within said bidirectional delta file by using a single pointer.

14. The method according to 1, substantially as described and illustrated.

15. The system according to claim 12, substantially as described and illustrated.

16. The program storage device according to claim 13, substantially as described and illustrated.
